(19) United States
(12) Patent Application Publication
(10) Pub. No.: US 2019/0037059 A1
(43) Pub. Date: Jan. 31, 2019

(54) NON-EXCLUSIVE DUAL-MODE MOBILE DEVICE

(71) Applicant: Salah MACHANI, Toronto (CA)

(72) Inventor: Salah MACHANI, Toronto (CA)

(21) Appl. No.: 15/658,737

(22) Filed: Jul. 25, 2017

(51) Int. Cl. H04M 1/02

(52) U.S. Cl. CPC H04M 1/0202; H04M 2250/14; H04M 2250/12; H04M 2250/16

(57) ABSTRACT

A mobile device including a first central processing unit (CPU) controlling operation of a first non-exclusive mode of the device having a first display associated therewith, and a second CPU controlling operation of a second non-exclusive mode of the device having a second display associated therewith; a plurality of individually functioning hardware resources, wherein each of said individually functioning hardware resources is accessible by only one of said first or said second CPU; and a plurality of shared hardware resources accessible by both of said first and said second CPU.

### FIELD OF THE INVENTION

The invention relates generally to mobile device, such as cellular telephones, and more particularly to a dual-mode mobile device having shared and non-shared hardware and/or software components.

### BACKGROUND

With the proliferation of mobile devices, such as smartphones, tablets, smart watches and laptops into both business and personal lives, many businesses and other organizations have been forced to confront the issue of individual users using personal, and oftentimes unsecure devices for business purposes. Sometimes use in this way is done with business approval and sometimes without it. Many business have encouraged users to make use of their personal devices for business purposes, but this is done with some hesitation by both parties. On the one hand, employees are reluctant to cede control of their devices and privacy over to their employer, and on the other hand, employers must ensure that confidential information is protected and only securely accessed by the employee.

This has led to many users carrying multiple devices to avoid the hassle and issues related to combining personal and work devices. The problems associated with carrying multiple devices are self-evident, from the very need to have two physical devices on hand to having to become familiar with two sets of software.

These problems have mostly been addressed on the software side, for example by implementing solutions and techniques known as application containerization and virtualization to isolate users' work spaces from their personal spaces on the device. However, these solutions have failed to live up to the promised security and privacy benefits, in part due to their associated costs and differences in software on different mobile devices.

Other situations where users are switching between devices, or in some instances swapping out SIM cards on the same device include travelling users looking to access different rates or data plans in different countries.

Other situations where users are switching between devices, or in some instances swapping out SIM cards on the same device include travelling users looking to access different rates or data plans in different countries.

There is accordingly a need in the art for improvements to mobile devices intended to be used for dual purposes.

### SUMMARY OF THE INVENTION

In one embodiment of the invention, there is provided a mobile device having a first central processing unit (CPU) controlling operation of a first non-exclusive mode of the device having a first display associated therewith, and a second CPU controlling operation of a second non-exclusive mode of the device having a second display associated therewith; a plurality of individually functioning hardware resources, wherein each of said individually functioning hardware resources is accessible by only one of said first or said second CPU; a plurality of shared hardware resources accessible by both of said first and said second CPU.

In one aspect of the invention, the shared hardware resources include one or more of a battery, a speaker, a microphone, a wireless communications transceiver, a GPS device and an NFC controller.

In another aspect of the invention, the individually functioning hardware resources include a pair of one or more of power management integrated circuits, application processors, memory, touch screen controllers, and digital baseband processors.

In another aspect of the invention, there is further provided a first SIM card module and a second SIM card module in communication with first and second application processors, respectively; wherein each of the SIM modules operates independently from each other.

In another aspect of the invention, there is further provided one or more sensors configured to provide an indication as to whether the first display or the second display is user facing.

In another aspect of the invention, one of said first and second modes is managed by a user of the device and the other of said first and second modes is managed using a mobile device management (MDM) server by an enterprise, wherein the enterprise enforces security policies and usage restrictions on the device.

In another aspect of the invention, the first mode and said second mode include voice and/or data services provided by two different carriers.

In another aspect of the invention, there is further provided a first operating system stored on a first memory and executed by said first CPU, and a second operating system stored on a second memory and executed by said second CPU.

In another aspect of the invention, there is further provided a physical switch on an exterior of the mobile device for switching between said first mode and said second mode.

In another aspect of the invention, the first mode is designated as a high priority mode and said second mode a low priority mode; wherein said high priority mode is provisioned to interrupt operation of the low priority mode upon detection of a predetermined condition.

In another aspect of the invention, the predetermined condition is a telephone call received by said high priority mode.

In another aspect of the invention, there is further provided a means control by the user for overriding said high and low priority modes.

In another aspect of the invention, upon booting up the mobile device, hardware resources associated with said first mode are powered up before hardware resources associated with said second mode.

In another aspect of the invention, there is further provided at least one power button for booting up the mobile device, wherein said at least one power button has one or more positions selected from (a) said first and second modes are both off, (b) said first and second modes are both turned on, (c) said first mode is turned on and said second mode is turned off, and (d) said first mode is turned off and said second mode is turned on.

In another aspect of the invention, software applications executed by said hardware resources associated with said first mode are run before hardware resources associated with said second mode are powered up.

In another aspect of the invention, there is further provided one or more sensors including an accelerometer and a gyroscope configured to determine a tilt direction of either the first display or the second display.

In another aspect of the invention, a user may interact with one of said first and second non-exclusive modes at a time, and each of said first and second non-exclusive modes remains active independently of said user interaction.

In another aspect of the invention, the first and second non-exclusive modes operate on different operating systems.

In another aspect of the invention, there is further provided a means is provided to detect which display is facing a user, and said first or second mode associated with said display facing the user is made an active mode.

In another aspect of the invention, the other of said first or second mode which is not the active mode is automatically put into a sleep mode to conserve battery power.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a perspective view of an exemplary dual mode mobile device taken from the top.

FIG. 2 is a perspective view of the device of FIG. 1 taken from the bottom.

FIG. 3 shows an illustrative representation of the device of FIG. 1 with the screen cut away for illustrative purposes.

FIG. 4 is a schematic illustration of one embodiment of the invention.

### DETAILED DESCRIPTION OF THE INVENTION

The invention describes an alternate approach to dual mode or dual functionality mobile devices in which hardware improvements over prior art mobile devices are disclosed and software enhancements disclosed which enable the improved hardware to operate as intended. The dual mode nature of the device as herein described is expressly intended to be non-exclusive. That is, a user may interact with one or both modes at any given time based on the interface with which the user is accessing the mode. Specifically, one more is not powered down when the other is active, and the mobile device may detect calls, for example, on both modes at any given point in time. The term “dual mode” as referenced throughout this description is used interchangeably with “non-exclusive dual mode”.

Principally, the invention attempts to ensure complete hardware-level isolation of the user's personal space and the user's work space on a mobile device, and preferably separation of work and personal voice, data and text channels. References to “personal space” in this description refer to storage areas, settings, applications, security and other aspects of a user's mobile device under which the user is to have complete control and autonomy for use in their day-to-day life. References to “work space” or the like refer to settings imposed on a mobile device by a third-party, particularly an employer or business entity who desires to ensure confidentiality and/or control of data they own when it is on a user's personal device.

To this end, the invention discloses a dual mode mobile device having a set of common and/or shared hardware components, and a set of individually functioning hardware components to ensure a complete isolation of personal and work space data. The shared components are generally those that are unrelated to data control or access on the phone but serve a function related to operation of the device on a fundamental level distinct from the data on the device. The individually functioning hardware components are those that relate directly to data stored on the device and are not capable of software-level separation to an extent sufficient to ensure data security or privacy.

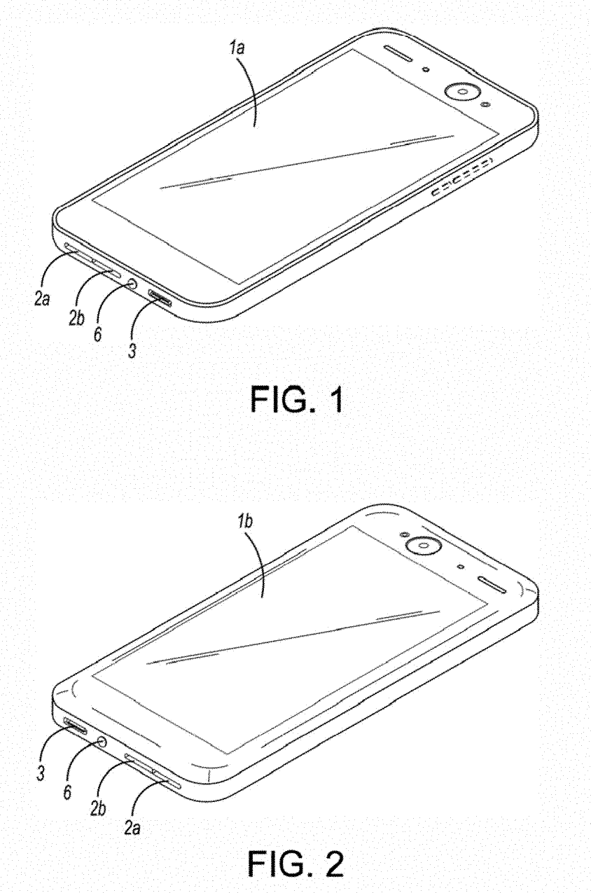

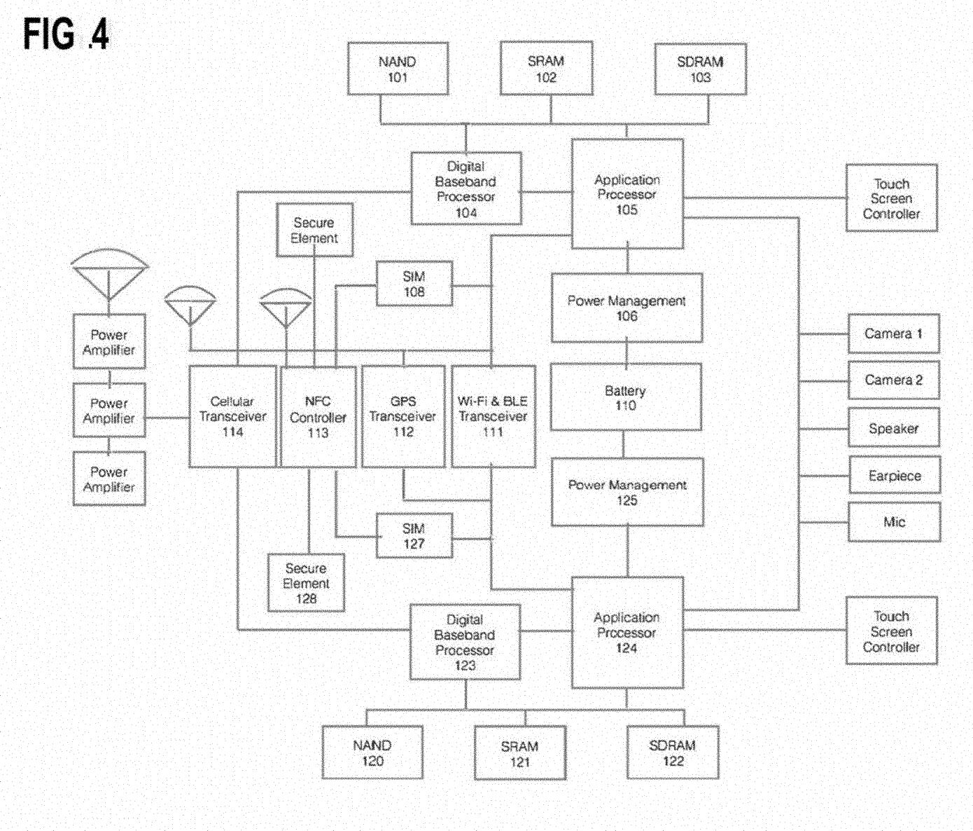

With reference now to FIG. 4, there is shown a schematic illustration of various hardware components in the dual-mode mobile device. Each of the components in FIG. 1 are configured to be within a unitary mobile device physical body that a user could readily carry around.

The dual mode mobile device preferably includes a single battery 110 from which a pair of power management integrated circuits 106, 125 draw power for distribution to a first application processor 105 responsible for applications on the user's personal space and a second application processor 124 responsible for applications on the user's work space. The battery 110 may be a standard prior art mobile device battery commonly used in the mobile devices. The power management integrated circuits 106, 125 manage power for each of the two host systems. Both circuits 106, 125 would typically be implemented on a common system block, and would be active anytime the mobile device is turned on.

The application processors 105, 124 are preferably implemented as systems on a chip designed to support applications running in the operating systems of either the personal mode or the work mode of the mobile device. The application processors 105, 124 represent the first stage, hardware level bifurcation of personal and work spaces, operating completely independently of one another to deliver all system capabilities needed to support the device applications, depending on the mode in which the mobile device is operating. Device applications supported by the application processors include memory management, graphics processing and multimedia decoding. Such application processors are generally known in the art, but the functioning and inclusion of dual application processors, and which processor is prioritized and activated as will be described further below is a novel contribution to the art.

The first application processor 105 is configured to be in communication with a first touch screen controller, controlling a first touchscreen, a digital baseband processor 104 and a group of common components which the mobile device uses to communicate with external sources. These include wireless communications transceivers including a WiFi and BlueTooth transceiver 111 and a cellular transceiver 114. An optional GPS transceiver 112 and an NFC controller 113 also form part of the singular group of components as these resources are shared by both the personal and work elements on the device.

Similarly, the second application processor 124 is configured to be in communication with a second touch screen controller, controlling a second touchscreen, a second digital baseband processor 123 and the group of common components including the Wi-Fi and Bluetooth transceiver 111, the cellular transceiver 114, and optional GPS transceiver 112 and NFC controller 113.

The dual mode mobile device also has two SIM card modules 108, 127 in communication with respective application processors 105 and 123. Each of the SIM card modules operates independently from each other and grants access to two phone numbers, and other subscriber identity features of the mobile device.

In a more generic sense than the preferred embodiment described above, the dual mode mobiles device includes at least one controller, such as a general processor, which may be coupled to a vocoder. The vocoder may in turn be coupled to a speaker and a microphone. The general processor may also be coupled to at least one memory for each of the personal and work sides of the mobile device. The at least one memory may be a non-transitory tangible computer readable storage medium that stores processor-executable instructions. For example, the instructions may include routing communication data relating to the first or second subscription though a corresponding baseband-RF resource chain.

The at least one memory may store operating system (OS), as well as user application software and executable instructions, separately and running independently for each of the work and personal modes of the device. The memories may also store application data, such as pre-determined user preference settings and/or rules for automatically determining when to commence voice/text conversation mode.

The general processor and memory may each be coupled to at least one baseband processor. Each SIM may be associated with a baseband-RF resource chain. Each baseband-RF resource chain may include baseband modem processor to perform baseband/modem functions for communications on a SIM, and one or more amplifiers and radios, referred to generally herein as RF resources. Baseband/modem functions may also be physically or logically integrated with the vocode. For example, the vocoder and modem functions may be implemented in a digital signal processor.

The RF resources may each be transceivers that perform transmit/receive functions for the associated SIM. The RF resources may include separate transmit and receive circuitry, or may include a transceiver that combines transmitter and receiver functions. The RF resources may be coupled to a wireless.

Optionally, the general purpose processor, memory, baseband processor, and RF resources may be included in a system-on-chip device. The first and second SIMs and their corresponding interfaces may be external to the system-on-chip device. Further, various input and output devices may be coupled to components of the system-on-chip device, such as interfaces or controllers.

The dual mode mobile device may determine how to handle an incoming voice call on one SIM while participating in an active call on the other SIM. Generally however, each the personal and work modes are fully functional independently of each other (subject to the limitations of the user being able to manage both sides of the device).

Physical Device

Turning now to FIGS. 1-32, there is shown an exemplary implementation of the dual mode device of the invention, having a first screen 1a on one side of the device and a second screen 1b on a second side of the device. A single charging, USB slot 3 is also shown, although any other connection slots or receptacles for chargers, data transfer, audio, video cords are also contemplated. A first SIM card slot 2a is shown proximate a second SIM card slot 2b, although the invention is not limited to these positions. In some variations, it may be advantages to position SIM slots on opposite sides of the device, or have these slots otherwise demarcated to provide an indication prior to turning on the phone as to which mode of the phone will appear on which screen.

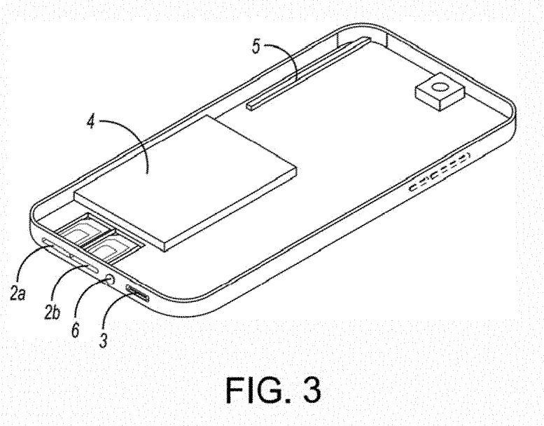

An exemplary switch 6 is also illustrated which may be used to toggle between the screens 1a and 1b, although other ways of switching between modes as herein described are also contemplated. A representative battery 4 and antenna are shown in FIG. 3. Volume, power and other typical buttons are shown on the side of the device.

Switching Between Personal and Work Modes

In order to place the dual mode device into either the personal mode or the work mode, a switching mechanism must be provided. In the simplest example, a physical switch is provided on the phone which allows a user to select the work mode or the personal mode. Such a physical switch will then cause only those components related to the personal or work mode (as selected) to be active in order to conserve batter power on the device.

Alternatively, the switching between work and personal spaces could be accomplished based on a predetermined priority of events. For example, if a telephone call is received by the dual mode device on the work SIM card, the device automatically switches into work mode. Similarly, rules can be set to ignore work mode switching during certain hours of the day or on weekends as may be desired by the user. This type of switching could be accomplished by the implementation of a switching circuit or module accessible via both application processors 105, 124 to select which application processor is given priority over the device at any given moment. These rules could be driven by different applications on either the work space or the personal space. In another example, an email received on the work space would automatically switch the dual mode device into work mode to receive the email and provide a notification to the user.

In yet another embodiment of the invention, both the work mode and personal mode may be simultaneously active at any given moment, and accessible by the respective touch screen, depending on which screen the user is facing. This could be accomplished by way of sensors detecting where the user is located and accordingly which screen is being viewed, or alternatively by the user simply tapping a portion of the screen that is desired to be activated.

The device can be managed by an Enterprise using MDM server. The Enterprise can enforce many security policies and restrictions. For example, disable the use of the camera, force the user to enter a passcode to unlock the device, etc.

Dual SIM Cards

As used herein, the terms “SIM”, “SIM card” and “subscriber identification module” are used interchangeably to mean an integrated circuit, embedded into a removable card, that stores an International Mobile Subscriber Identity (IMSI), related keys, and/or other information used to identify and/or authenticate a wireless device to a wireless telecommunication network. The term SIM may also be used as shorthand reference to a particular communication network or subscriber account with which the SIM is associated, since the information stored in a SIM enables the wireless device to establish a communication link with a particular network, thus the SIM and the communication network correlate to one another.

Each SIM may enable communications over different communications networks using the same or different wireless communication protocols. In another embodiment, two SIMs may enable communications over the same network using the same wireless communications protocol.

The wireless networks with which the dual mode device communications via the SIMS may be cellular data networks, and may use channel access methods including, but not limited to, Frequency Division Multiple Access (FDMA), Time Division Multiple Access (TDMA), Code Division Multiple Access (CDMA), Universal Mobile Telecommunications Systems (UMTS) (particularly, Long Term Evolution (LTE)), Global System for Mobile Communications (GSM), Wi-Fi, PCS, G-3, G-4, or other protocols that may be used in a wireless communications network or a data communications network.

The dual mode mobile device may simultaneously access two networks; or may also establish connections with Wi-Fi access points, which may connect to the Internet.

The dual mode mobile device is capable of making a voice or data call to a third party device using one of the SIMs, and may also receive a voice call or other data transmission from a third party. The third party device may be any of a variety of devices, including, but not limited to, a mobile phone, laptop computer, PDA, server, etc.).

A SIM in the various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM), with each SIM configured and optimized for either personal or work use. The work SIM may be locked by an employer such that only limited changes or data may be stored on the work SIM based on the employer's mobile communications policy.

The dual SIM cards 108, 127 are provided in separate SIM slots on the dual mode device such that a user can replace either or both SIM cards independently from one another. For example, if changing carriers for a personal device, while keeping the carrier for the work-side of the device, or vice-versa. The relationship between the two SIM cards may be either passive, active or operate in a stand-by relationship.

A passive relationship between the SIM cards requires a user-activated switch (either hardware or software based) to select whether the personal or work SIM is active at any given moment. The passive relationship implementation is preferred where maximum isolation between the personal and work modes is desired, and preferably by way of a physical hardware switch.

In a standby mode relationship, both SIMs may be accessed through time multiplexing techniques to send and receive signals over the common transceiver and activate a particular SIM when a call is placed or received via that side of the device. Optionally, when a call is active the other SIM is locked out so as not to interrupt the call. However, in one variation of the invention, work mode calls may be prioritized and personal calls automatically placed on hold or a warning given to the user that a work mode call is incoming.

In an active relationship, the dual mode device is equipped with separate transceivers for each SIM card allowing them to be active simultaneously.

In one example, the dual mode device may receive an incoming voice call on an RF resource associated with the first SIM. The wireless device may determine whether a voice call is already active on the device on an RF-resource associated with the second SIM. If there is no active call on the wireless device, the incoming voice call may be handled according to normal call processing. If there is another active voice call on the second SIM, the wireless device may notify the user of the incoming voice call, such as by playing an audio clip, blinking lights, displaying a notification message, etc. The user may be prompted for input to select whether to activate the incoming call for processing, after which a delay may be provided to ensure sufficient time for the user to terminate the existing call. Of course, other options may also be provided, such as to send a call to voicemail or place it on extended hold.

In an alternative embodiment, the dual mode device may automatically perform the call switching functions of determination without requiring user input. That is, the device may, based on prior user settings, designate a particular contact or group of contacts as “high priority.” If an incoming voice call is received from such contact (for example, work contacts), upon determining that another active call exists through a different SIM on the device, the device may automatically convert the active call to a hold mode, or play an automated message directing the other participant in the call to leave a message, thus allowing the user to answer the high priority call according to normal voice call processes without having to hang up on the first call.

In an alternative embodiment, the device may operate using a single SIM card, where such a SIM card is capable of handling telephone and data communications to two different phone numbers.

Boot Sequencing

On powering up the dual mode device, or otherwise waking it from a sleep or standby mode, a series of system level checks are preferably initiated to provide power to the various shared and isolated resources in a manner that optimizes the intended use of the dual mode device.

For example, on powering on the device, each of the power management circuits 106, 125 are powered up to activate their respective application processors 105, 124. In the preferred embodiment, the work application processor 125 is powered (ie. booted) before the personal mode application processor 105. Downstream applications and functionality associated with the work mode of the phone are thus also booted up first and given priority over the booting up of the personal mode of the mobile device. In this manner, data and wireless communications that are predetermined to be of a higher priority (in this example, work related data and wireless communications) are notified or given priority access to hardware resources over lower priority data and wireless communications.

Preferably, the user will have some ability to determine which mode of the phone is given priority, for example by one of the SIM slots being designated as the primary mode SIM and the other the secondary mode SIM. Another way for the user to define such priorities is through root level settings.

Power Conservation

Power management in prior art mobile devices is generally known where the device has a single screen and battery. Various examples exist, with common examples being the Linux and Android power management architectures. In the preferred embodiment, the present invention uses a power conservation methodology built upon the Android power management architecture. However, certain practical adaptations are made to account for the dual mode nature of the device. Specifically, motion sensors such as an accelerometer and a gyroscope, are used to determine which screen is user-facing or activated at any given point in time. Power is then directed to the power-drawing hardware components which are active for the given mode of the device currently in use. For example, if the device is determined to be tilted forward for a short period of time, the back-device side CPU can be shut down, the screen turned off and all running applications suspended with their states saved to memory, overriding any wake locks. Similarly, if the device is placed horizontally, the mode of the device on the underside will have its CPU shut down.

The suspended, or shut-down, device will have its power restored as soon as the device is flipped over and the power button pressed by the user, for example. Power consumption on a dual-mode device with two screens as herein disclosed can be costly, and the aforementioned modifications attempt to maximize and extend the life of the shared battery charge.

In one variation of the invention, a user setting is enabled whereby the user may provide conditions on battery usage. One such condition would be to preserve a predetermined percentage of the battery for a mode of the device that is more critical, typically the work mode of the device. For example, the user may choose to reserve at least ten percent of the battery exclusively for work mode use, and software provisions at the root level of the phone may enable this option to be implemented.

General System Implementation

The various illustrative elements described in connection with the embodiments disclosed herein may be implemented as electronic hardware, computer software, or combinations of both. To clearly illustrate this interchangeability of hardware and software, various illustrative components have been described above generally in terms of their functionality. Whether such functionality is implemented as hardware or software depends upon the particular application and design constraints imposed on the overall system. A person skilled in the art may implement the described functionality in varying ways for each particular application, but such implementation decisions should not be interpreted as causing a departure from the scope of the present invention.

The hardware used to implement the invention may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory processor-readable storage medium. The steps of a method or algorithm disclosed herein may be embodied in a processor-executable software module which may reside on a non-transitory computer-readable storage medium. Tangible, non-transitory processor-readable storage media may be any available media that may be accessed by a processor of a computer, mobile computing device or a wireless communication device.

It is also contemplated that the two modes of the device may have two different operating systems or operating system configurations. For example, the word mode could have enforced security settings which lock down the operating system to a greater degree, whereas the personal mode would be more user-customizable.

The device can be managed by an Enterprise using MDM server. The Enterprise can enforce many security policies and restrictions. For example, disable the use of the camera, force the user to enter a passcode to unlock the device, etc.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein. All references cited herein are incorporated by reference.

1. A mobile device comprising
a first central processing unit (CPU) controlling operation of a first non-exclusive mode of the device having a first display on a first side of the device associated therewith, and a second CPU controlling operation of a second non-exclusive mode of the device having a second display on a second side of the device associated therewith;
a plurality of individually functioning hardware resources, wherein each of said individually functioning hardware resources is accessible by only one of said first or said second CPU;
a plurality of shared hardware resources accessible by both of said first and said second CPU.

2. The mobile device according to claim 1, wherein said shared hardware resources include one or more of a battery, a speaker, a microphone, a wireless communications transceiver, a GPS device and an NFC controller.

3. The mobile device according to claim 1, wherein said individually functioning hardware resources include a pair of one or more of power management integrated circuits, application processors, memory, touch screen controllers, and digital baseband processors.

4. The mobile device according to claim 1, further comprising a first SIM card module and a second SIM card module in communication with first and second application processors, respectively; wherein each of the SIM modules operates independently from each other.

5. The mobile device according to claim 1, further comprising one or more sensors configured to provide an indication as to whether the first display or the second display is user facing.

6. The mobile device according to claim 4, wherein one of said first and second modes is managed by a user of the device and the other of said first and second modes is managed using a mobile device management (MDM) server by an enterprise, wherein the enterprise enforces security policies and usage restrictions on the device.

7. The mobile device according to claim 1, wherein said first mode and said second mode include voice and/or data services provided by two different carriers.

8. The mobile device according to claim 1, further comprising a first operating system stored on a first memory and executed by said first CPU, and a second operating system stored on a second memory and executed by said second CPU.

9. The mobile device according to claim 1, further comprising a physical switch on an exterior of the mobile device for switching between said first mode and said second mode.

10. The mobile device according to claim 1, wherein said first mode is designated as a high priority mode and said second mode a low priority mode; wherein said high priority mode is provisioned to interrupt operation of the low priority mode upon detection of a predetermined condition.

11. The mobile device according to claim 10, wherein said predetermined condition is a telephone call received by said high priority mode.

12. The mobile device according to claim 10, further comprising a means controllable by the user for overriding said high and low priority modes, and further comprising a means controllable by the user for preserving a predetermined percentage of battery power for said high priority mode.

13. The mobile device according to claim 1, wherein upon booting up the mobile device, hardware resources associated with said first mode are powered up before hardware resources associated with said second mode.

14. The mobile device according to claim 13, further comprising at least one power button for booting up the mobile device, wherein said at least one power button has one or more positions selected from (a) said first and second modes are both off, (b) said first and second modes are both turned on, (c) said first mode is turned on and said second mode is turned off, and (d) said first mode is turned off and said second mode is turned on.

15. The mobile device according to claim 14, wherein software applications executed by said hardware resources associated with said first mode are run before hardware resources associated with said second mode are powered up.

16. The mobile device of claim 1, further comprising one or more sensors including an accelerometer and a gyroscope configured to determine a tilt direction of either the first display or the second display.

17. The mobile device according to claim 1, wherein a user may interact with one of said first and second non-exclusive modes at a time, and each of said first and second non-exclusive modes remains active independently of said user interaction.

18. The mobile device according to claim 1, wherein said first and second non-exclusive modes operate on different operating systems.

19. The mobile device according to claim 18, wherein a means is provided to detect which display is facing a user, and said first or second mode associated with said display facing the user is made an active mode.

20. The mobile device according to claim 19, wherein the other of said first or second mode which is not the active mode is automatically put into a sleep mode to conserve battery power.
